(19) United States
(12) Patent Application Publication
(10) Pub. No.: US 2026/0217131 A1
(43) Pub. Date: Jul. 30, 2026

(54) Pedal Actuation for the Longitudinal Control of a Motor Vehicle With an Electrical Drive Machine

(71) Applicant: Bayerische Motoren Werke Aktiengesellschaft, Muenchen (DE)

(72) Inventor: Thomas WAGNER, Reichertshausen (DE)

(21) Appl. No.: 18/722,659

(22) PCT Filed: Jan. 11, 2023
(86) PCT No.: PCT/EP2023/050558

§ 371 Date: Jun. 21, 2024

(30) Foreign Application Priority Data
Jan. 31, 2022 (DE) 10 2022 102 152.1

(51) Int. Cl. B60L 15/20

(52) U.S. Cl. CPC B60L 15/20; B60L 2250/26

(57) ABSTRACT

A longitudinal control device and a method for a motor vehicle with an electrical drive machine, comprising: an accelerator pedal for specifying a driver intention; a control unit coupled to the accelerator pedal for detecting an accelerator pedal position and an accelerator pedal speed, and to the drive machine to control a drive torque; accelerator pedal characteristics, in particular an accelerator pedal characteristic map, which the control unit accesses to determine an intended drive torque from the driver intention specified by way of the accelerator pedal position; wherein the control unit determines and/or controls an intended drive torque gradient according to a driver intention.

### BACKGROUND AND SUMMARY

This disclosure relates to a device and a method for the longitudinal guidance of a motor vehicle with an electric drive motor.

In motor vehicles powered by an internal combustion engine, the driver-requested torque specified by the driver via an accelerator pedal is generally calculated by a motor control unit depending on the respective accelerator pedal position. The accelerator pedal characteristics are here described by a map stored in the control unit. This map of the accelerator pedal characteristics represents the driver-requested torque depending on the accelerator pedal position and the speed of the drive motor. A factor is, for example, here identified from the map, on the basis of which the desired motor torque is calculated in the control unit and, based thereon, motor variables such as the amount of fuel and/or air which needs to be supplied and/or a corresponding ignition timing are determined.

It is moreover known to provide a manual switching function in vehicles powered by an internal combustion engine, wherein the driver can switch into a sport mode by manual actuation of a command device. In sport mode, a switch is made to maps configured for sport mode in which the driver's request is likewise identified depending on the angle of the accelerator pedal and the speed of the motor and a corresponding control signal for activating the internal combustion engine is identified. The maps configured for sport mode differ from those of the normal mode only in that relatively high specified torques are generated with just relatively small pedal travel and transmitted to the internal combustion engine.

Corresponding maps are also known for motor vehicles which are powered by an electric drive motor. Maps are sometimes used here which replicate the specific properties of the use of an internal combustion engine. The maps used generally do not fully exploit the possible spread of the acceleration characteristics when electric motors are used in motor vehicles.

Against this background, an object of the disclosure is to improve longitudinal guidance of an electrically powered motor vehicle.

One aspect of the disclosure relates to a longitudinal guidance device for a motor vehicle with an electric drive motor. The longitudinal guidance device has: (a) an accelerator pedal for specifying a driver's request; (b) a control unit which can be coupled on the input side to the accelerator pedal for detecting an accelerator pedal position and an accelerator pedal speed, and on the output side to the drive motor for activating a drive torque, in particular depending on the driver's request; (c) accelerator pedal characteristics, in particular a map of accelerator pedal characteristics, which can be accessed by the control unit for identifying a desired drive torque from the driver's request specified by way of the accelerator pedal position.

The control unit is moreover configured to identify a desired drive torque gradient depending on a driver's request specified by way of the accelerator pedal speed and/or to activate it at the electric drive motor.

Such a longitudinal guidance device for an electrically powered motor vehicle enables a large and immediate spread of the acceleration characteristics because the accelerator pedal speed is taken into account when inputting a driver's request for acceleration.

Thus, in an embodiment, a maximum acceleration can, for example, be made available as it were immediately without a perceptible delay for the driver when the driver presses the pedal as quickly as possible. A much slower build-up of acceleration can accordingly be selected when the driver presses the pedal carefully or slowly.

A further aspect of the disclosure relates to a method for the longitudinal guidance of a motor vehicle with an electric drive motor, in particular by way of a longitudinal guidance device according to an embodiment of the disclosure, having at least the following method steps which can be performed in the stated order or a different order known to a person skilled in the art: (i) detecting an accelerator pedal speed when a driver's request for acceleration is input by a driver of the vehicle; (ii) identifying a desired drive torque gradient depending on the detected accelerator pedal speed, ; (iii) activating the desired drive torque gradient in such a way that the driver perceives the build-up of drive torque as an immediate reaction to their actuation of the pedal, i.e. in particular within no more than 200 ms, preferably 100 ms (milliseconds).

According to one embodiment, the different drive torque gradients differ at different accelerator pedal speeds greatly such that an applied longitudinal acceleration gradient of the motor vehicle which can be perceived directly by the driver is activated by at least 50 m/s³, in particular ar least 75 or 100 m/s³, higher or lower: depending on whether the drive torque gradient is set for a lowest accelerator pedal speed or a highest accelerator pedal speed.

In this way, very sporty acceleration characteristics with a massive jerk, but also very comfortable acceleration characteristics with gentle acceleration gradients, can be activated without switching a driving mode.

According to one embodiment, the accelerator pedal characteristics, in particular the map of the accelerator pedal characteristics, specify desired drive torque gradients depending on the accelerator pedal speed.

Thus, profiles, already typical in the development of the motor vehicle, of an accelerator pedal speed when the accelerator pedal is pressed can be linked to acceleration profiles typically desired with the corresponding profile. The control unit can thus call up a predetermined acceleration profile depending on the measured acceleration pedal speed.

According to one embodiment, the control unit is designed in such a way that a lower drive torque gradient or a higher degree of modulatability is ensured at a low accelerator pedal speed, and a higher drive torque gradient or a higher degree of spontaneity of the drive is ensured at a higher accelerator pedal speed.

Thus, both acceleration characteristics which correspond to a very sporty vehicle and those which correspond to a very luxury vehicle can be activated in a vehicle and/or in a driving mode, and this is achieved just by the driver varying the speed of actuation of the accelerator pedal when accelerating. In the case of electrically powered motor vehicles, these variations or this spread can be much more pronounced than in the case of vehicles with internal combustion engines because in the case of electric drive motors the delay time to build up a maximum acceleration is many times less than in the case of internal combustion engines and even far below a perceptible level. In addition, a much higher acceleration gradient can also be implemented, at least in the short term, in the case of typical electric drive motors in motor vehicles than in the case of the internal combustion engines which are typically installed.

According to one embodiment, in particular in a specified driving mode of the motor vehicle, the driver's request in terms of the desired drive torque is specified by the accelerator pedal position and in particular not by the accelerator pedal speed, and/or the driver's request in terms of the desired drive torque gradient is specified by the accelerator pedal speed. The disclosure thus enables variation of only the acceleration up to the final speed desired with the final pedal position; in contrast to changing between different driving modes where different final speeds are associated with the same final pedal position.

According to one embodiment, a final speed to be activated in accordance with the driver's request is not identified depending on the accelerator pedal speed. The use of known maps of accelerator pedal characteristics in terms of the relationships between the accelerator pedal position and the drive torque can thus be used with the disclosure. In order to implement the disclosure, it is then only necessary to supplement the accelerator pedal characteristics with the relationships between the accelerator pedal speed and the drive torque gradient.

According to one embodiment, the accelerator pedal speed relates, in particular only, to a build-up of acceleration in a period of time which begins with the pedal being operated in order to build up the acceleration, in particular therefore with a delay time which is not perceivable for the driver. Longitudinal guidance can thus be achieved with an immediacy which cannot be achieved with internal combustion engines. According to an embodiment, this makes it possible, in the event of rapid actuation of the accelerator pedal, to activate a massive jerk which is experienced in the perception of the driver as simultaneous with the operation of the pedal.

According to one embodiment, different drive torque gradients are provided for different pedal speed profiles within 500 ms (i.e. milliseconds) after the beginning of the operation of the pedal in order to build up the acceleration. An immediate spread of the acceleration characteristics can thus be achieved in electrically powered vehicles.

According to one embodiment, the time taken for a requested final drive torque to be applied differs for different pedal speed profiles. Thus, the time taken for a predetermined final speed of the vehicle to be reached during operation can differ for the same final accelerator pedal position.

According to one embodiment, for a maximum pedal speed profile, a maximum provided drive torque is applied at the electric motor within 200 ms, in particular 100 ms, and/or a maximum provided drive torque gradient is applied within 100 ms, in particular 50 ms. The immediacy of the acceleration response of the electric motor with the operation of the accelerator pedal can thus be conveyed to the driver.

### BRIEF DESCRIPTION OF THE DRAWINGS

Further advantages and possible applications of the disclosure can be found in the following description in conjunction with the figures.

FIG. 1 shows schematically a longitudinal guidance device according to an exemplary embodiment of the disclosure in a motor vehicle which can be powered electrically.

FIG. 2 shows, according to an exemplary embodiment of the disclosure, in each case the development of the acceleration gradients and the development of the vehicle longitudinal acceleration in a diagrammatic illustration over time for four different accelerator pedal speed profiles.

### DETAILED DESCRIPTION OF THE DRAWINGS

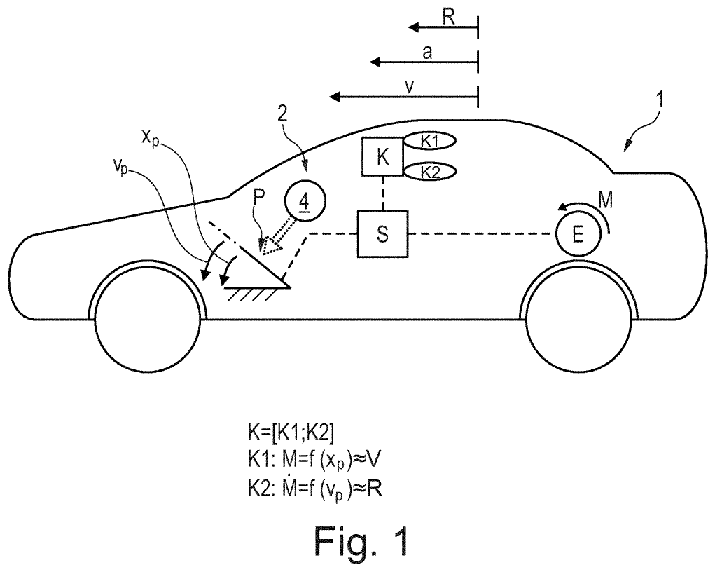

A longitudinal guidance device 2 according to an exemplary embodiment of the disclosure in a motor vehicle 1 which can be powered electrically, with an electric drive motor E, is shown schematically in FIG. 1.

The longitudinal guidance device 2 has an accelerator pedal P for specifying a driver's request 4.

The longitudinal guidance device 2 moreover has a control unit S which can be coupled to the accelerator pedal P for detecting an accelerator pedal position x_p and an accelerator pedal speed v_p, and to the drive motor E for activating a drive torque M. The control unit S may be associated with or a part of an Engine Control Unit (ECU) or Engine Control Module (ECM), and/or may comprise a controller (e.g., processor, microprocessor, etc.) and a memory (e.g., hard disk, ROM, RAM, PROM, EEPROM, etc.) for storing programs, software, and/or logic to be executed by the controller.

The longitudinal guidance device 2 moreover has accelerator pedal characteristics K, stored in the memory, which the control unit S can access in order to identify a desired drive torque M from the driver's request 4 specified by way of the accelerator pedal position x_p.

The control unit S is configured to identify and activate a desired drive torque gradient R depending on a driver's request 4 specified by way of the accelerator pedal speed v_p.

The accelerator pedal characteristics K have two maps of accelerator pedal characteristics K1 and K2 which the control unit S can access.

The map of accelerator pedal characteristics K1 contains in each case one assigned drive torque M for different accelerator pedal positions x_p. This drive torque M is at least roughly proportional to a driver's request 4 for a final speed.

The map of accelerator pedal characteristics K2 contains in each case one assigned drive torque gradient M_punkt for different accelerator pedal speeds v_p. The drive torque gradient M punkt is at least roughly proportional to an acceleration gradient, in other words a jerk, of the motor vehicle 1 which corresponds in particular to a driver's request 4 for jerk.

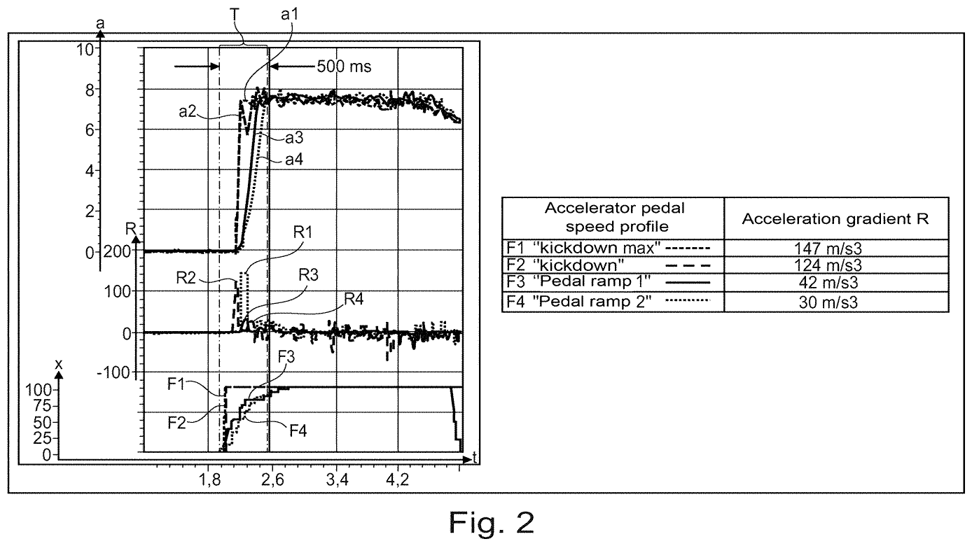

In each case the development of the acceleration gradients (in other words the jerk R) R1, R2, R3, R4 and the development of the vehicle longitudinal accelerations a1, a2, a3, a4, is according to an exemplary embodiment of the disclosure shown for four different accelerator pedal speed profiles F1, F2, F3, F4 in FIG. 2.

Particularly relevant in this exemplary embodiment is a time interval T which begins with the new actuation of the accelerator pedal (cf accelerator pedal speed profiles F) and does not extend beyond 500 ms in a range which is immediately perceptible to the driver.

By virtue of the possibility of being able to activate the electric drive motor of the motor vehicle via the control unit with such a short time delay with the highest accelerations a and acceleration gradients R, the developments R1 and a1 of the accelerator pedal speed profile F1 result. The accelerator pedal speed profile F1 replays a maximum kickdown in which the driver desires a maximum acceleration a1 and also a maximum acceleration gradient R1.

With incrementally less of a jerk, the progressions a2 and R2 run to the accelerator pedal speed profile F2 (“soft kickdown”), the progressions a3 and R3 run to the accelerator pedal speed profile F3 (“steep pedal ramp”), and the progressions a4 and R4 run to the accelerator pedal speed profile F4 (“soft pedal ramp”), correspondingly.

The strength of the strongest jerk at R1 (147 m/s³) exceeds the strength of the strongest jerk at R4 (30 m/s³) by just under 120 m/s³ such that an exceptionally strong spread of the acceleration characteristics can be achieved within a single driving mode with the exemplary embodiment of the disclosure.

### LIST OF REFERENCE SIGNS

motor vehicle 1
longitudinal guidance device 2
vehicle longitudinal accelerations a1, a2, a3, a4
accelerator pedal speed profiles F1, F2, F3, F4
accelerator pedal characteristics K
maps of accelerator pedal characteristics K1, K2
drive torque M
drive torque gradient M_punkt or M
accelerator pedal P
acceleration gradient (jerk) R1, R2, R3, R4
control unit S
time interval T
accelerator pedal speed v_p or vₚ
accelerator pedal position x_p or xₚ

1.-11. (canceled)

12. A longitudinal guidance device for a motor vehicle with an electric drive motor, comprising:
an accelerator pedal for specifying a driver's request,
a control unit coupled to the accelerator pedal for detecting an accelerator pedal position and an accelerator pedal speed, and to the drive motor for activating a drive torque, and
accelerator pedal characteristics accessed by the control unit for identifying a desired drive torque from the driver's request specified by way of the accelerator pedal position,
wherein the control unit identifies and/or activates a desired drive torque gradient depending on a driver's request specified by way of the accelerator pedal speed.

13. The longitudinal guidance device according to claim 12, wherein the accelerator pedal characteristics specify desired drive torque gradients depending on the accelerator pedal speed.

14. The longitudinal guidance device according to claim 12, wherein the control unit is configured such that a lower drive torque gradient or a higher degree of modulatability is ensured at a low accelerator pedal speed, and a higher drive torque gradient or a higher degree of spontaneity of the drive is ensured at a higher accelerator pedal speed.

15. The longitudinal guidance device according to claim 12, wherein in a specified driving mode of the motor vehicle, the driver's request in terms of the desired drive torque is specified by the accelerator pedal position and/or the driver's request in terms of the desired drive torque gradient is specified by the accelerator pedal speed.

16. The longitudinal guidance device according to claim 12, wherein a final speed to be activated in accordance with the driver's request is not identified depending on the accelerator pedal speed.

17. The longitudinal guidance device according to claim 12, wherein the accelerator pedal speed relates to a build-up of acceleration in a period of time which begins with the pedal being operated in order to build up the acceleration.

18. The longitudinal guidance device according to claim 12, wherein different drive torque gradients are provided for different pedal speed profiles within 500 ms after the beginning of the operation of the pedal in order to build up the acceleration.

19. The longitudinal guidance device according to claim 12, wherein the time taken for a requested final drive torque to be applied differs for different pedal speed profiles.

20. The longitudinal guidance device according to claim 12, wherein for a maximum accelerator pedal speed profile, a maximum provided drive torque is applied within 200 ms, and/or a maximum provided drive torque gradient is applied within 100 ms.

21. A method for the longitudinal guidance of a motor vehicle with an electric drive motor, by way of a longitudinal guidance device according to claim 12, comprising:
detecting an accelerator pedal speed when a driver's request for acceleration is input,
identifying a desired drive torque gradient depending on the detected accelerator pedal speed, and
activating the desired drive torque gradient so that the driver perceives the build-up of drive torque as an immediate reaction to their actuation of the pedal.

22. The method according to claim 21, wherein the different drive torque gradients differ at different accelerator pedal speeds such that a longitudinal acceleration gradient of the motor vehicle which is applied directly is activated by at least 50 m/s³, depending on whether the drive torque gradient is set for a lowest accelerator pedal speed or a highest accelerator pedal speed.
